(19) United States
(12) Patent Application Publication
(10) Pub. No.: US 2014/0211751 A1
(43) Pub. Date: Jul. 31, 2014

(54) METHOD FOR TRANSMITTING AN ENHANCED CONTROL SIGNALING, BASE STATION AND USER EQUIPMENT

(71) Applicant: FUJITSU LIMITED, Kawasaki-shi (JP)

(72) Inventors: Yuantao ZHANG, Beijing (CN); Yi ZHANG, Beijing (CN); Yi WANG, Beijing (CN); Hua ZHOU, Beijing (CN)

(73) Assignee: FUJITSU LIMITED, Kawasaki-shi (JP)

(21) Appl. No.: 14/226,451

(22) Filed: Mar. 26, 2014

Related U.S. Application Data
(63) Continuation of application No. PCT/CN2011/080505, filed on Sep. 30, 2011.

(51) Int. Cl. H04L 5/00; H04W 72/04

(52) U.S. Cl. CPC H04L 5/0035; H04W 72/042
USPC 370/330; 370/329

(57) ABSTRACT

A method for transmitting an enhanced control signaling, a base station and user equipment (UE) are applicable to a coordinated multipoint transmission mode. The method including: transmitting, by a pico base station, an enhanced physical control format indication signaling (E-PCFICH) to UE configured with the mode, the E-PCFICH including control signaling length, wherein the control signaling length is of a pico cell, or a maximum value of control signaling lengths of a macro cell and a pico cell. With the embodiments of the invention, the E-PCFICH including control signaling length is adopted in a pico cell, so that the UE can determine a starting position of the data area PDSCH of the pico cell according to the control signaling length, thereby solving the problem that the data area of the pico cell cannot be accurately determined under the CoMP mode, and ensuring that the UE correctly receives data.

### CROSS-REFERENCE TO RELATED APPLICATIONS

This is a continuation of International Application No. PCT/CN2011/080505, filed on Sep. 30, 2011, now pending, the contents of which are herein wholly incorporated by reference.

### TECHNICAL FIELD

The present invention relates to the field of communications, and particularly, to a method for transmitting an enhanced control signaling, a base station and user equipment (UE).

### BACKGROUND

FIG. 1 is a structure diagram of a subframe of a Long Term Evolution (LTE) system. The physical control signaling of the LTE system includes a physical control format indicator channel

(PCFICH), a physical downlink control channel (PDCCH) and a physical hybrid-ARQ indicator channel (PHICH).

As shown in FIG. 1, the PCFICH is generally located on the first OFDM symbol of the subframe to indicate the number of orthogonal frequency division multiplexing (OFDM) symbols occupied by a control area, typical value of the PCFICH being 1, 2 or 3. The PDCCH is used for transmitting scheduling information of uplink and downlink data, including uplink power control information etc. The PHICH is used for transmitting a decoded response signal (i.e., acknowledge/non-acknowledge (ACK/NACK) signal) corresponding to an uplink data signal. To be noted, the resources occupied by the channels described herein are the logical resources mapped by the channels, rather than the actually mapped physical resources.

In LTE Release 11, the coordinated multi-point (CoMP) transmission is an important technique to improve the system performance. For example, the dynamic cell selection (DCS) is an important branch of the CoMP.

In the process of implementing the present invention, the inventor finds that in LTE Release 11, enhanced channels of various control signalings are introduced due to many reasons. For example, enhanced PCFICH (E-PCFICH), an enhanced PDCCH (E-PDCCH) and an enhanced PHICH (E-PHICH) are introduced, respectively. However, there is still no effective solution to configure the above three enhanced control signalings and to transmit them. In addition, after the above three enhanced control signalings are configured, some problems will occur in the application under the CoMP mode, which also cannot be solved at present.

To be noted, the above introduction to the technical background is just made for the convenience of clearly and completely describing the technical solutions of the present invention, and to facilitate the understanding by a person skilled in the art. It shall not be deemed that the above technical solution is known to a person skilled in the art just because it has been illustrated in the Background section of the invention.

### SUMMARY

The embodiments of the invention provide a method for transmitting an enhanced control signaling, a base station and user equipment. Under the circumstance of introducing the enhanced control signaling, the problem of transmitting the enhanced control signaling is solved, and the problems occurring when applying the enhanced control signaling into the CoMP transmission are also solved.

An aspect of the embodiments of the invention provides a method for transmitting an enhanced control signaling, applicable to a coordinated multipoint transmission mode, the method including:

transmitting, by a pico base station, an enhanced physical control format indication signaling (E-PCFICH) to user equipment configured with the CoMP mode, the enhanced physical control format indication signaling including control signaling length;

wherein the control signaling length is of a pico cell, or a maximum value of control signaling lengths of a macro cell and a pico cell.

Another aspect of the embodiments of the invention provides a method for determining a starting position of a physical downlink shared channel, applicable to a coordinated multipoint transmission mode, including:

acquiring, by user equipment, a maximum value of control signaling lengths of a macro cell and a pico cell; and

determining, by the user equipment, a starting position of a data area of the pico cell according to the maximum value.

Another aspect of the embodiments of the invention provides a pico base station, applicable to a coordinated multipoint transmission mode, the pico base station including:

a first transmitting unit, configured to transmit an enhanced physical control format indication signaling including control signaling length to user equipment configured with the mode;

wherein the control signaling length is of a pico cell, or a maximum value of control signaling lengths of a macro cell and the pico cell.

Another aspect of the embodiments of the invention provides user equipment configured with a coordinated multipoint transmission mode, and the user equipment including:

a second information acquiring unit, configured to acquire a maximum value of control signaling lengths of a macro cell and a pico cell in a set maintained by the user equipment; and

a first determining unit, configured to determine a starting position of a data area of the pico cell according to the maximum value.

Another aspect of the embodiments of the invention provides a method for transmitting an enhanced control signaling, applicable to a coordinated multipoint transmission mode, the method including:

transmitting, by a base station of a main service cell, first downlink control information to user equipment;

wherein the first downlink control information is transmitted in a control area of the main service cell, and includes a base station identifier indicating a base station that transmits second downlink control information;

the second downlink control information is transmitted in a data area, and includes a base station identifier indicating a base station that transmits data.

Another aspect of the embodiments of the invention provides a method for receiving data, applicable to a coordinated multipoint transmission mode, the method including:

detecting, by user equipment, first downlink control information (DCI) from a traditional area of a main service cell, and acquiring a position where second DCI is present from the first DCI; wherein the position where the second DCI is present is a base station identifier CI of a base station where the second DCI is present;

detecting, by the user equipment, the second DCI in a base station to which the acquired base station identifier corresponds; and

receiving, by the user equipment, data from the base station to which the base station identifier acquired from the first DCI corresponds.

Another aspect of the embodiments of the invention provides a base station, of a main service cell under a coordinated multipoint transmission mode, the base station including:

a first information transmitting unit, configured to transmit first downlink control information to user equipment, wherein the first downlink control information is transmitted in a control area of the main service cell, and includes a base station identifier indicating a base station that transmits second downlink control information;

the second downlink control information is transmitted in a data area, and includes a base station identifier indicating a base station that transmits data.

Another aspect of the embodiments of the invention provides user equipment, the user equipment including:

a first detecting unit, configured to detect first DCI from a traditional area of a main service cell, and to acquire a position where second DCI is present from the first DCI; wherein the position where the second DCI is present is a base station identifier CI of a base station where the second DCI is present;

a second detecting unit, configured to detect the second DCI in a base station to which the base station identifier corresponds according to the base station identifier detected by the first detecting unit; and

a first data receiving unit, configured to receive data from the base station to which the base station identifier detected by the first detecting unit corresponds.

Another aspect of the embodiments of the invention provides a method for transmitting an enhanced control signaling, applicable to a coordinated multipoint transmission mode, the method including:

transmitting, by a base station, an enhanced downlink control signaling (E-PDCCH) to user equipment if the enhanced downlink control signaling and a scheduled downlink shared channel (PDSCH) occupy different frequency domain resources, the enhanced downlink control signaling including a base station identifier indicating a base station that transmits data; and

transmitting, by a base station that transmits the scheduled downlink shared channel, the enhanced downlink control signaling to the user equipment if the enhanced downlink control signaling and the scheduled downlink shared channel occupy the same frequency domain resource and different time domain resources;

wherein the enhanced downlink control signaling is transmitted in a data area.

Another aspect of the embodiments of the invention provides a method for receiving data, applicable to a coordinated multipoint transmission mode, the method including:

searching for, by user equipment, an enhanced downlink control signaling of the user equipment according to predetermined information of transmission position of the enhanced downlink control signaling, the enhanced downlink control signaling including a base station identifier indicating a base station that transmits data;

acquiring, by the user equipment, the base station identifier of the base station that transmits data from the enhanced downlink control signaling; and

receiving, by the user equipment, data from the base station to which the base station identifier corresponds.

Another aspect of the embodiments of the invention provides a base station, applicable to a coordinated multipoint transmission mode, the base station including:

a second information transmitting unit, configured to transmit an enhanced downlink control signaling (E-PDCCH) to user equipment if the enhanced downlink control signaling and a scheduled downlink shared channel (PDSCH) occupy different frequency domain resources, the enhanced downlink control signaling including a base station identifier indicating a base station that transmits data; and to transmit the enhanced downlink control signaling to the user equipment if the enhanced downlink control signaling and the scheduled downlink shared channel occupy the same frequency domain resource and different time domain resources, the base station being the same base station that transmits the scheduled downlink shared channel; wherein the enhanced downlink control signaling is transmitted in a data area.

Another aspect of the embodiments of the invention provides user equipment, applicable to a coordinated multipoint transmission mode, the user equipment including:

an information detecting unit, configured to search for an enhanced downlink control signaling of the user equipment according to predetermined information of transmission position of the enhanced downlink control signaling, the enhanced downlink control signaling including a base station identifier indicating a base station that transmits data; and

a second data receiving unit, configured to acquire the base station identifier of the base station that transmits data from the enhanced downlink control signaling, and to receive data from the base station to which the base station identifier corresponds.

Another aspect of the embodiments of the invention provides a method for transmitting a response signal, applicable to a coordinated multipoint transmission mode, the method including:

transmitting, by a base station, a decoded response signal corresponding to an uplink data signal transmitted by user equipment in an enhanced hybrid-ARQ indicator channel (E-PHICH); wherein the base station transmits the acquired response signal and data needing to be transmitted to the user equipment simultaneously to the user equipment.

Another aspect of the embodiments of the invention provides a base station, applicable to a coordinated multipoint transmission mode, the base station including:

a signal transmitting unit, configured to transmit a decoded response signal corresponding to an uplink data signal transmitted by user equipment in an enhanced hybrid-ARQ indicator channel (E-PHICH); wherein the signal transmitting unit transmits the acquired response signal and data needing to be transmitted to the user equipment simultaneously to the user equipment.

Another aspect of the embodiments of the invention provides a computer-readable program, when executed in a base station, enabling a computer to perform the aforementioned method for transmitting an enhanced control signaling in the base station.

Another aspect of the embodiments of the invention provides a storage medium storing a computer-readable program, wherein the computer-readable program enables a computer to perform the aforementioned method for transmitting an enhanced control signaling in a base station.

Another aspect of the embodiments of the invention provides a computer-readable program, when executed in user equipment, enabling a computer to perform the aforementioned method for determining a starting position of PDSCH in the user equipment.

Another aspect of the embodiments of the invention provides a storage medium storing a computer-readable program, wherein the computer-readable program enables a computer to perform the aforementioned method for determining a starting position of PDSCH in user equipment.

Another aspect of the embodiments of the invention provides a computer-readable program, when executed in user equipment, enabling a computer to perform the aforementioned method for receiving data in the user equipment.

Another aspect of the embodiments of the invention provides a storage medium storing a computer-readable program, wherein the computer-readable program enables a computer to perform the aforementioned method for receiving data in user equipment.

The embodiments of the invention have the following beneficial effect: under the circumstance of introducing the enhanced control signaling such as E-PCFICH, E-PDDCH and E-PHICH, the embodiments of the invention solve the problem existed under the CoMP transmission mode for transmitting the enhanced control signaling, and also solve the problems occurring when applying the enhanced control signaling into the CoMP transmission.

With reference to the subsequent descriptions and drawings, the particular embodiments of the invention are specifically disclosed to indicate the implementations of the principle of the invention. It shall be appreciated that the scope of the embodiments of the invention is not limited thereto, and the embodiments of the invention comprise many changes, modifications and equivalents within the scope of the spirit and clauses of the accompanied claims.

Features described and/or illustrated with respect to one embodiment can be used in one or more other embodiments in a same or similar way, and/or by being combined with or replacing the features in other embodiments.

To be noted, the term “comprise/include” used herein specifies the presence of feature, element, step or component, not excluding the presence or addition of one or more other features, elements, steps or components or combinations thereof.

### BRIEF DESCRIPTION OF THE DRAWINGS

The above and other objectives, features and advantages of the embodiments of the invention will be more obvious from the following detailed descriptions given with reference to the drawings, in which:

FIG. 1 is a structure diagram of a subframe of an LTE system;

FIG. 2 is a structure diagram of a typical DCS.

FIG. 3 is a flowchart of a method for transmitting an E-PCFICH according to Embodiment 1 of the invention;

FIG. 4 is a flowchart of a method for determining a starting position of a PDSCH according to Embodiment 2 of the invention;

FIG. 5 is a flowchart of a method for transmitting an E-PCFICH according to Embodiment 3 of the invention;

FIG. 6 is a flowchart of a method for determining a starting position of a PDSCH according to Embodiment 4 of the invention;

FIG. 7 is a structure diagram of UE according to Embodiment 6 of the invention; FIG. 8 is a structure diagram of a pico base station according to Embodiment 7 of the invention;

FIG. 9 is a structure diagram of UE according to Embodiment 8 of the invention;

FIG. 10A is a structure diagram of a one-step E-PDCCH;

FIG. 10B is another structure diagram of a one-step E-PDCCH;

FIG. 11 is a structure diagram of a two-step E-PDCCH;

FIG. 12 is a flowchart of a method for transmitting/receiving an E-PDCCH according to Embodiment 9 of the invention;

FIG. 13 is a structure diagram of a macro base station according to Embodiment 10 of the invention;

FIG. 14 is a structure diagram of UE according to Embodiment 11 of the invention;

FIG. 15 is a flowchart of a method for receiving data of UE according to Embodiment 13 of the invention;

FIG. 16 is a structure diagram of a base station according to Embodiment 14 of the invention;

FIG. 17 is a structure diagram of UE according to Embodiment 15 of the invention;

FIG. 18 is a configuration diagram of an E-PHICH according to Embodiment 18 of the invention;

FIG. 19 is a flowchart of a method for transmitting a response signal according to Embodiment 19 of the invention; and

FIG. 20 is a structure diagram of a base station according to Embodiment 20 of the invention.

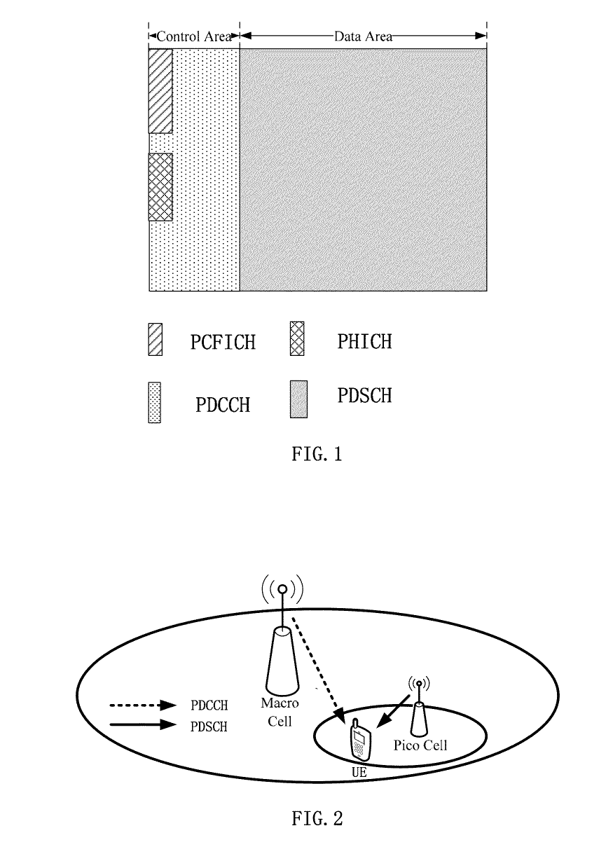

### DESCRIPTION OF THE EMBODIMENTS

Various embodiments of the invention will be described as follows with reference to the drawings. Those embodiments are just exemplary rather than limitations to the invention. In order that a person skilled in the art can easily understand the principle and the embodiments of the invention, the embodiments of the invention are described through a method for transmitting an enhanced control signaling, a method for determining a starting position of a PDSCH, and a method for transmitting a response signal, by taking the LTE-A/LTE system as an example. It shall be appreciated that the invention is not limited to the above system, and it is also suitable for other systems concerning the above problems.

Firstly, the DCS is taken as an example to describe the CoMP transmission. If certain UE is configured with the DCS mode, the UE may maintain a set of cells. FIG. 2 is a structure diagram of a typical DCS. As shown in FIG. 2, the set maintained by the UE configured with the DCS mode includes a macro cell and an adjacent pico cell. Data transmitted to the UE may be dynamically switched between the macro cell and the pico cell, and a transmitting point for transmitting control signaling which schedules the transmission of data of the UE may be different from a transmitting point for transmitting the data. As shown in FIG. 2, control signaling PDCCH of the UE is coming from the macro cell, while data signal is coming from the pico cell. One of the advantages of the DCS is that the cell load balance can be realized, e.g., if the number of UE in the macro cell is relatively more while the number of UE in the pico cell is relatively small, the UE in the macro cell may occupy the resources of the pico cell so as to receive data. The above description is made through an example where the set maintained by the UE includes a macro cell and a pico cell in the DCS mode, but the invention is not limited thereto. Although the enhanced control signaling is introduced, there is no effective solution to configure and transmit them, and some problems will be caused by the application in the CoMP mode. The embodiments of the invention are proposed to solve the above problems.

Next, as the enhanced control signaling, descriptions are given for the E-PCFICH, the E-PDCCH and the E-PHICH respectively. In the following embodiments, the UE is configured with the CoMP transmission mode, such as the DCS mode, and maintains a set of cells, which will not be repeated in the subsequent descriptions.

Descriptions are made for the E-PCFICH.

Currently, there is no conclusion of where or how to transmit the E-PCFICH. The following typical scenarios are considered.

For example, the set maintained by the UE includes a macro cell and a pico cell which have different control area lengths, while the UE can only correctly detect the PCFICH of the macro cell rather than the PCFICH of the pico cell. In that case, a typical example is that in a certain subframe, the control signaling size of the macro cell is n1 OFDM symbols, and the control signaling size of the pico cell is n2 OFDM symbols, wherein n1<n2. For UE configured with the DCS mode, if the number of OFDM symbols occupied by a control signaling is determined by detecting the PCFICH of the macro cell to determine the starting position of the data area PDSCH, the UE determines that the PDSCH is transmitted from the n1+1^{th} OFDM symbol of the pico cell, while the n1+1^{th} OFDM symbol of the pico cell is the control signaling, thus the data cannot be correctly received.

The embodiment of the present invention provides a method for transmitting an E-PCFICH, which specifies the transmitting area of the E-PCFICH, how to transmit the E-PCFICH and the content carried by the E-PCFICH. The method may solve the problem that the UE side cannot properly determine the starting position of the PDSCH of the pico cell, and may receive data correctly.

In the embodiment, the E-PCFICH is adopted in the pico cell, including a control signaling length which is of the pico cell or a maximum value of control signaling lengths of the macro cell and the pico cell. Thus the UE can acquire the maximum value of the control signaling lengths of the macro cell and the pico cell, and determine the starting position of the data area PDSCH of the pico cell according to the maximum value, thereby the above problems can be solved, and the UE may receive data correctly. Next, the embodiment will be detailedly described with reference to the drawing.

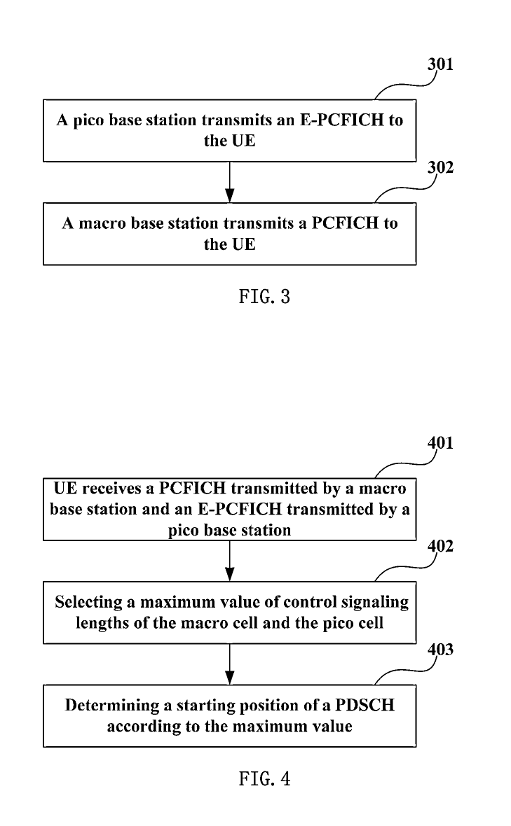

FIG. 3 is a flowchart of a method for transmitting an E-PCFICH according to Embodiment 1 of the invention. As shown in FIG. 3, the method includes:

Step 301: a pico base station transmits an E-PCFICH to the UE.

In the embodiment, the E-PCFICH includes a control signaling length of the pico cell, such as N2, i.e., the length is N2 OFMD symbols.

Step 302: a macro base station transmits a PCFICH to the UE.

In the embodiment, the PCFICH includes a control signaling length of the macro cell, such as N1, i.e., the length is N1 OFMD symbols.

The orders of steps 301 and 302 can be exchanged, or notified to be executed.

FIG. 4 is a flowchart of a method for determining a starting position of a PDSCH according to Embodiment 2 of the invention. As shown in FIG. 4, the method includes:

Step 401: the UE receives a PCFICH transmitted by a macro base station and an E-PCFICH transmitted by a pico base station.

In the embodiment, after receiving the PCFICH transmitted by the macro base station, the UE can acquire a control signaling length N1 of a macro cell therefrom; and after receiving the E-PCFICH transmitted by the pico base station, the UE can acquire a control signaling length N2 of a pico cell therefrom.

Step 402: the UE selects a maximum value of the control signaling lengths of the macro cell and the pico cell.

In the embodiment, if N1>N2, i.e., the control signaling length of the macro cell is larger than the control signaling length of the pico cell, N1 is selected as the maximum value.

Step 403: the UE determines a starting position of the PDSCH of the pico cell according to the maximum value.

In the embodiment, the starting position of the PDSCH of the pico cell is determined according to N1, thereby avoiding the situation that the starting position of the PDSCH is wrongly determined and the data cannot be received correctly.

For example, if N1=3 and N2=2, the starting position of the PDSCH is determined according to N1=3, i.e., the UE can determine that the data (PDSCH) is transmitted from the 4^{th} OFMD symbol of the pico cell.

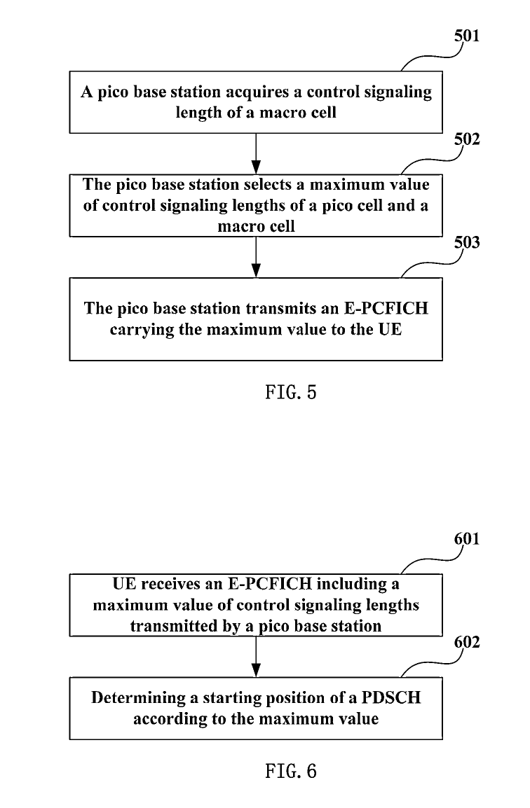

FIG. 5 is a flowchart of a method for transmitting an E-PCFICH according to Embodiment 3 of the invention. As shown in FIG. 5, the method includes:

At the network side, a pico cell transmits an E-PCFICH.

Step 501: a pico base station acquires a control signaling length of the macro cell.

In the embodiment, the pico base station may exchange information with the base station of the macro cell to acquire the control signaling length of the macro cell, such as N1.

Step 502: the pico base station selects a maximum value of the control signaling lengths of the pico cell and the macro cell.

In the embodiment, the pico base station may compare its control signaling length N2 with the control signaling length N1 of the macro cell to find the maximum value;

for example, in the embodiment, N1>N2.

Step 503: the pico base station transmits an E-PCFICH carrying the maximum value to the UE.

In the embodiment, the maximum value is N1.

FIG. 6 is a flowchart of a method for determining a starting position of a PDSCH according to Embodiment 4 of the invention. As shown in FIG. 6, the method includes:

Step 601: the UE receives an E-PCFICH transmitted by a pico base station.

In the embodiment, after receiving the E-PCFICH transmitted by the pico base station, the UE may acquire the maximum value N1.

Step 602: the UE determines the starting position of the PDSCH of the pico cell according to the maximum value.

In the embodiment, the starting position of the PDSCH is determined according to N1, thereby avoiding the situation that the starting position of the PDSCH is wrongly determined and the data cannot be received correctly.

For example, if N1=3 and N2=2, the starting position of the PDSCH is determined according to N1=3, i.e., the UE can determine that the data (PDSCH) is transmitted from the 4^{th} OFMD symbol of the pico cell.

In Embodiments 1-4, examples are given by assuming N1>N2. If N2>N1, the UE determines the starting position of the PDSCH of the pico cell according to N2. The situation is similar to N1>N2, and herein is omitted.

The embodiments of the invention further provide a pico base station and UE, as described in subsequent Embodiments 5-8. Since the pico base station and the UE solve the problems in principles are similar to those of the method for transmitting an enhanced control signaling and the method for determining the starting position of the PDSCH, which are based on the pico base station and the UE, the implementations of the methods can be applied to the implementations of the pico base station and the UE, and the repeated contents are omitted.

Embodiment 5 of the invention further provides a pico base station, including a first transmitting unit for transmitting an E-PCFICH including a control signaling length to the UE, wherein the control signaling length is of a pico cell.

In the embodiment, if the control signaling length of the pico cell is N2, it means that the control signaling length is N2 OFDM symbols. Thus, after receiving the E-PCFICH, the UE can acquire the control signaling length N2 of the pico cell therefrom, and then determine a starting position of the PDSCH of the pico cell according to the maximum value between N2 and the control signaling length N1 of the macro cell acquired by the UE.

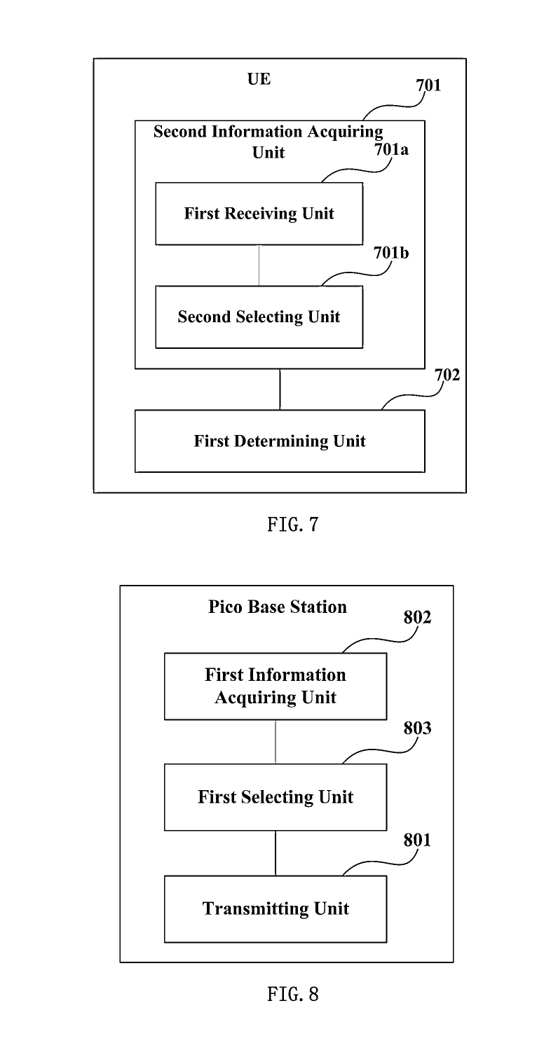

FIG. 7 is a structure diagram of UE according to Embodiment 6 of the invention. As shown in FIG. 7, the UE includes a second information acquiring unit 701 and a first determining unit 702, wherein,

the second information acquiring unit 701 is configured to acquire a maximum value of control signaling lengths of a macro cell and a pico cell; and the first determining unit 702 is configured to determine a starting position of a data area of the pico cell according to the maximum value.

In the embodiment, as shown in FIG. 7, the second information acquiring unit 701 may include a first receiving unit 701a and a second selecting unit 701b, wherein,

the first receiving unit 701a is configured to receive a PCFICH including a control signaling length of the macro cell transmitted by a macro base station and an E-PCFICH including a control signaling length of the pico cell transmitted by a pico base station; and the second selecting unit 701b is configured to select the maximum value of control signaling lengths of the pico cell and the macro cell.

As described above, the control signaling length of the macro cell is N1, the control signaling length of the pico cell is N2, and if N1>N2 herein, the second selecting unit 701b may select the maximum value between N1 and N2 according to the signaling received by the first receiving unit 701a, such as N1 herein. If N2>N1, the second selecting unit 701b selects the maximum value N2.

In the embodiment, the first receiving unit 701a of the UE receives the PCFICH including the control signaling length of the macro cell transmitted by the macro base station, and the E-PCFICH including the control signaling length of the pico cell transmitted by the pico base station. The second selecting unit 701b selects the maximum value of the control signaling lengths of the pico cell and the macro cell. The first determining unit 702 determines the starting position of the data area according to the maximum value. The process of determining the starting position of the PDSCH of the pico cell is similar to that described in Embodiment 2.

FIG. 8 is a structure diagram of a pico base station according to Embodiment 7 of the invention. As shown in FIG. 8, the pico base station includes a transmitting unit 801 which is configured to transmit an E-PCFICH including a control signaling length to the UE, wherein the control signaling length is a maximum value of control signaling lengths of the macro cell and the pico cell.

In that case, the pico base station may further include a first information acquiring unit 802 and a first selecting unit 803.

In the embodiment, the process of transmitting the E-PCFICH by the pico base station is as described in Embodiment 3. The first information acquiring unit 802 of the pico base station acquires a control signaling length of the macro cell. The first selecting unit 803 selects a maximum value of the control signaling lengths of the pico cell and the macro cell. The transmitting unit 801 transmits the E-PCFICH carrying the maximum value to the UE.

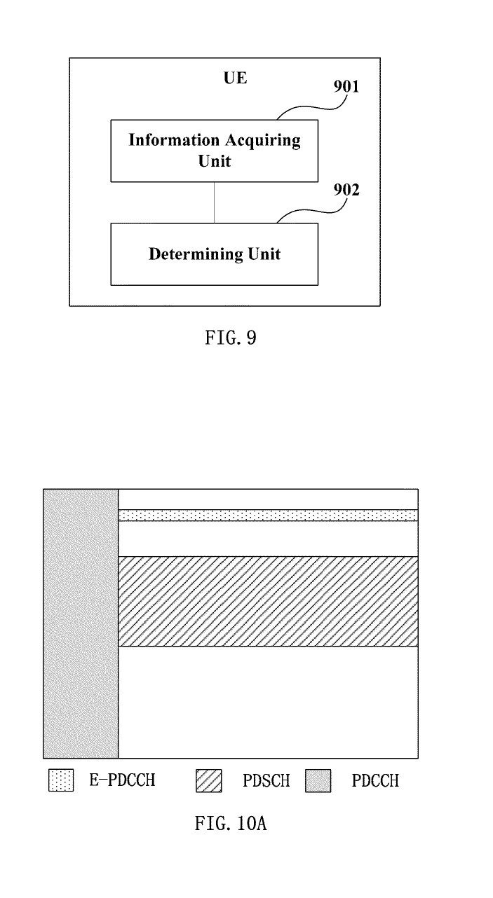

FIG. 9 is a structure diagram of UE according to Embodiment 8 of the invention. As shown in FIG. 9, being similar to Embodiment 6, the UE includes an information acquiring unit 901 and a determining unit 902, wherein the information acquiring unit 901 is specifically configured to receive an E-PCFICH including a control signaling length transmitted by a pico base station, wherein the control signaling length is a maximum value of control signaling lengths of the macro cell and the pico cell; and the determining unit 902 is configured to determine a starting position of a data area of the pico cell according to the maximum value.

In the embodiment, the process of determining the starting position of the PDSCH by the UE is as described in Embodiment 4, and the information acquiring unit 901 of the UE can acquire the maximum value by receiving the E-PCFICH transmitted by the pico base station. The determining unit 902 of the UE may determine the starting position of the PDSCH according to the maximum value. The process is similar to Embodiment 4, and herein is omitted.

In the above embodiment, the E-PCFICH is adopted in the pico cell, including a control signaling length which is of the pico cell or a maximum value of control signaling lengths of the macro cell and the pico cell. Thus the UE can acquire the maximum value of the control signaling lengths of the macro cell and the pico cell, and determine the starting position of the data area PDSCH of the pico cell according to the maximum value, thereby the above problems can be solved, and the UE may receive data correctly.

Next, descriptions are made for the E-PDCCH.

There are two possible structures for the E-PDCCH, i.e., one-step E-PDCCH and two-step E-PDCCH.

For the one-step E-PDCCH.

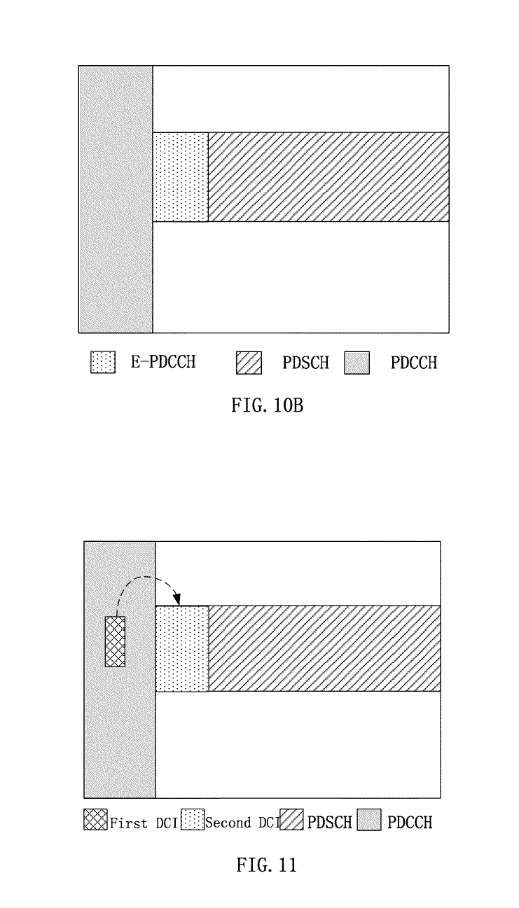

The one-step E-PDCCH is transmitted in a data area, and the UE determines the information included in the control signaling by one-step detection. Further, the one-step E-PDCCH includes two sub-structures. FIG. 10A is a structure diagram of one-step E-PDCCH, and FIG. 10B is another structure diagram of one-step E-PDCCH.

As shown in FIG. 10A, the E-PDCCH and Physical Downlink Shared Channel (PDSCH) scheduled by the E-PDCCH occupy different frequency domain resources, i.e., the structure of the one-step E-PDCCH shown in FIG. 10A is a Frequency-division Multiplexing (FDM) structure.

As shown in FIG. 10B, the E-PDCCH and PDSCH scheduled by the E-PDCCH may occupy the same frequency domain resource and different time domain resources, i.e., the structure of the one-step E-PDCCH shown in FIG. 10B is a FDM+TDM (Time-division Multiplexing) structure.

For the two-step E-PDCCH.

FIG. 11 is a structure diagram of two-step E-PDCCH. For the two-step E-PDCCH, the first step DCI is transmitted in a traditional area (i.e., the PDCCH), and the second step DCI is transmitted in a data area, wherein the first step DCI indicates the position of the second step DCI and other information.

Currently, there is no specific solution for transmitting the E-PDCCH. Next, the embodiments of the invention are described in detail with reference to the structures of the one-step E-PDCCH and the two-step E-PDCCH.

For the two-step E-PDCCH structure as shown in FIG. 11.

Embodiment 9 of the invention provides a method for transmitting an E-PDCCH, in the embodiment, the resource configuration of the E-PDCCH is as shown in FIG. 11. The method includes:

a main service cell transmits first DCI to UE, and specifically, a base station of the main service cell transmits the first DCI to the UE.

The first DCI is transmitted in the traditional area of the main service cell, i.e., the control area (the PDCCH area as shown in FIG. 11) of the main service cell. The first DCI includes a base station identifier (CI, cell identify) indicating a base station that transmits the second DCI. The second DCI is transmitted together with scheduled data in the data area (PDSCH area) by the same transmitting base station.

In the embodiment, the base station of the main service cell further notifies the UE whether to configure the UE with an E-PDCCH on each cell in a set maintained by the UE.

In that case, when detecting the E-PDCCH, the UE may firstly detect the first DCI from the traditional area of the main service cell, and acquire a position where the second DCI is present (i.e., a base station identifier CI of a base station where the second DCI is present) from the first DCI. Thus the UE can detect the second DCI from a base station to which the base station identifier corresponds to acquire related information in the second DCI, and the related information in the second DCI is similar to that of the DCI in the prior art, for example modulation mode, etc. In addition, since the second DCI is transmitted together with scheduled data in the data area by the same transmitting base station, the UE may further receive data from the base station to which the base station identifier corresponds.

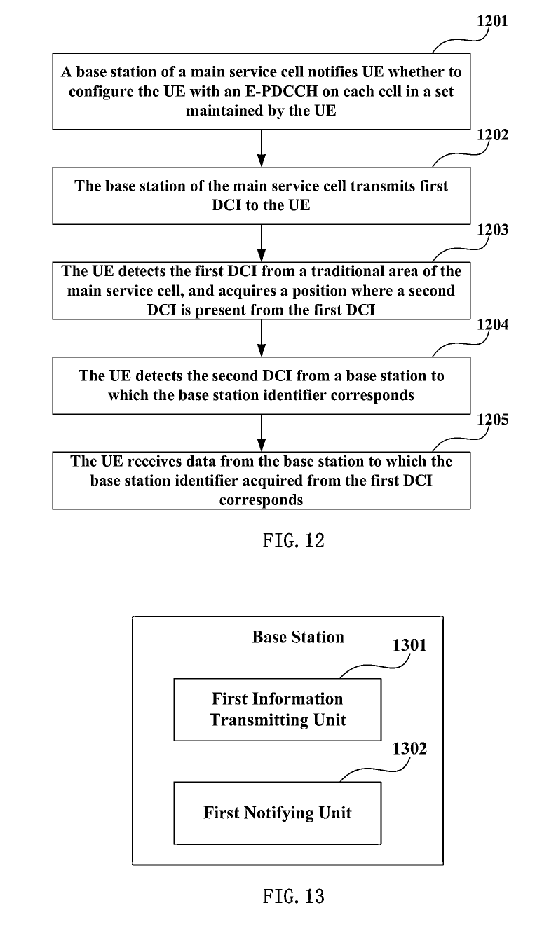

Next, the method for transmitting the E-PDCCH according to Embodiment 9 of the invention is described with reference to the drawing. As shown in FIG. 12, the method includes:

At the base station side.

Step 1201: the base station of the main service cell notifies the UE whether to configure the UE with an E-PDCCH on each cell in a set maintained by the UE;

Step 1202: the main service cell transmits first DCI to the UE, and specifically, a base station of the main service cell transmits the first DCI to the UE.

The first DCI is transmitted in the traditional area of the main service cell, i.e., the control area of the main service cell (the PDCCH area as shown in FIG. 11). The first DCI includes a base station identifier (CI, cell identify) indicating a base station that transmits second DCI. The second DCI is transmitted together with scheduled data in the data area (PDSCH area) by the same transmitting base station. The orders of the above steps 1201 and 1202 can be exchanged.

At the receiving terminal side, the process of receiving data by the terminal is as follows.

Step 1203: UE detects the first DCI from the traditional area of the main service cell, and acquires the position where the second DCI is present from the first DCI.

In which, the position where the second DCI is present is a base station identifier CI of a base station where the second DCI is present.

Step 1204: the UE detects the second DCI in a base station to which the base station identifier corresponds.

Step 1205: the UE receives data from the base station to which the base station identifier acquired from the first DCI corresponds.

Since the second DCI is transmitted together with scheduled data by the same transmitting base station, the UE may receive data from the base station where the second DCI is present.

FIG. 13 is a structure diagram of a base station according to Embodiment 10 of the invention, and the base station is of a main service cell. As shown in FIG. 13, the base station includes a first information transmitting unit 1301 and a first notifying unit 1302, wherein,

the first information transmitting unit 1301 is configured to transmit first DCI to the UE, wherein the first DCI is transmitted in a control area of the main service cell, includes a base station identifier indicating a base station that transmits the second DCI, and the second DCI is transmitted together with scheduled data in a data area by the same transmitting base station.

As shown in FIG. 13, the base station further includes a first notifying unit 1302 which is configured to notify the UE whether to configure the UE with an E-PDCCH on each cell in a set maintained by the UE.

For example, in the embodiment, if the set maintained by the UE includes a macro cell and a pico cell, the main service cell is the macro cell, and the base station of the main service cell is a macro base station.

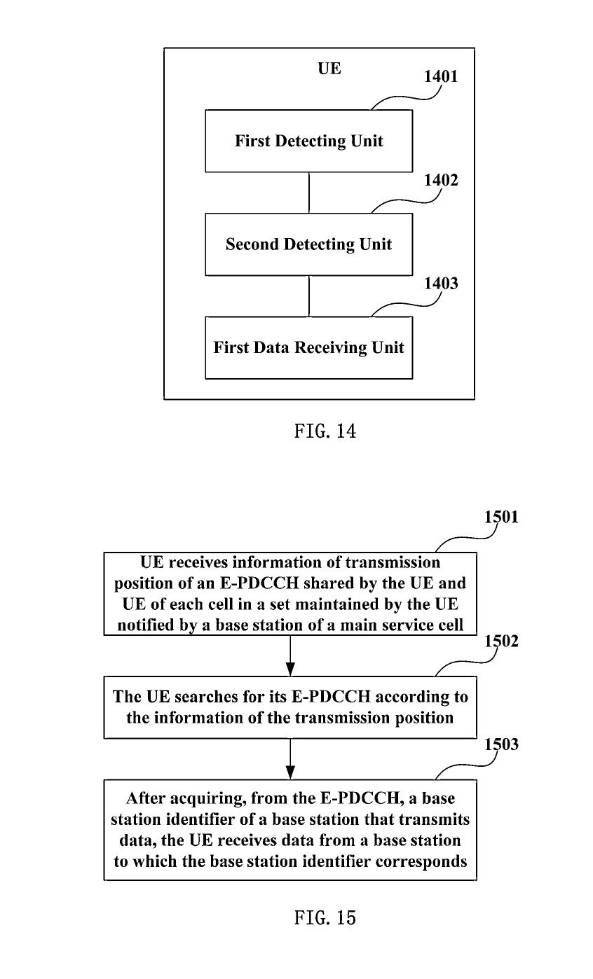

FIG. 14 is a structure diagram of UE according to Embodiment 11 of the invention. As shown in FIG. 14, the UE includes a first detecting unit 1401, a second detecting unit 1402 and a first data receiving unit 1403, wherein,

the first detecting unit 1401 is configured to detect first DCI from a traditional area of a main service cell, and to acquire a position where second DCI is present from the first DCI. The second detecting unit 1402 is configured to detect the second DCI from a base station to which a base station identifier corresponds according to the base station identifier detected by the first detecting unit 1401, so that the base station may acquire related information from the second DCI. The first data receiving unit 1403 is configured to receive data from the base station to which the base station identifier detected by the first detecting unit 1401 corresponds. In which, since the second DCI is transmitted together with scheduled data in the data area (PDSCH area) by the same transmitting base station, the first data receiving unit 1403 may receive data from the base station to which the base station identifier corresponds.

In the above embodiment, the processes of detecting the DCI by the first detecting unit 1401 and the second detecting unit 1402 is the same as those in the prior art, and herein are omitted.

As can be seen from the above embodiment, when detecting the E-PDCCH, the UE may firstly detect the first DCI from the traditional area of the main service cell, and acquire the position where the second DCI is present (i.e., a base station identifier CI of a base station where the second DCI is present) from the first DCI. Thus the UE can detect the second DCI from a base station to which the base station identifier corresponds, and then receive data from the base station according to the base station identifier.

For the one-step E-PDCCH structure in FIG. 10A.

Embodiment 12 of the invention provides a method for transmitting an E-PDCCH. In the embodiment, the resource configuration for the E-PDCCH is as shown in FIG. 10A. The method includes:

a base station configured with an E-PDCCH transmits the E-PDCCH to UE if the enhanced downlink control signaling (E-PDCCH) and a scheduled downlink shared channel (PDSCH) occupy different frequency domain resources, the E-PDCCH being transmitted in a data area and including a base station identifier indicating a base station that transmits data.

In the embodiment, if the structure as shown in FIG. 10A is adopted, the base station configured with the E-PDCCH may be of a cell in a set maintained by the UE. For example, if the set includes a macro cell and a pico cell, the base station may be either a macro base station or a pico base station, and the E-PDCCH transmitted by the base station indicates a base station identifier of a base station that transmits data. In that case, the transmitted E-PDCCH and the scheduled PDSCH may be transmitted at different cell base stations.

In the embodiment, the system may provide a shared position for the UE configured with the E-PDCCH, and each UE searches for its E-PDCCH at the shared position. In that case, the method further includes: a main service cell, such as the base station of a macro cell in the embodiment, notifies the UE of information of transmission position of E-PDCCH shared by UE of each cell in a set maintained by the UE, so that the UE searches for its E-PDCCH at corresponding position; after receiving the E-PDCCH, the UE may acquire a base station identifier of a base station that transmits data indicated by the E-PDCCH, and receive data from the base station to which the base station identifier corresponds.

FIG. 15 is a flowchart of a method for receiving data of UE according to Embodiment 13 of the invention. As shown in FIG. 15, the method includes:

step 1501: UE receives information of transmission position of E-PDCCH shared by the UE and UE of each cell in a set maintained by the UE notified by a base station of a main service cell.

In which, for example, the base station of the main service cell is a macro base station if the set maintained by the UE includes a macro cell and a pico cell.

Step 1502: the UE searches for its E-PDCCH according to the information of transmission position, the E-PDCCH indicates a base station identifier of a base station that transmits data.

In which, the UE may search for its E-PDCCH at the shared position, and the specific process may adopt any of the prior arts, which is omitted herein.

Step 1503: after acquiring, from the E-PDCCH, the base station identifier of the base station that transmits data, the UE receives data from the base station to which the base station identifier corresponds.

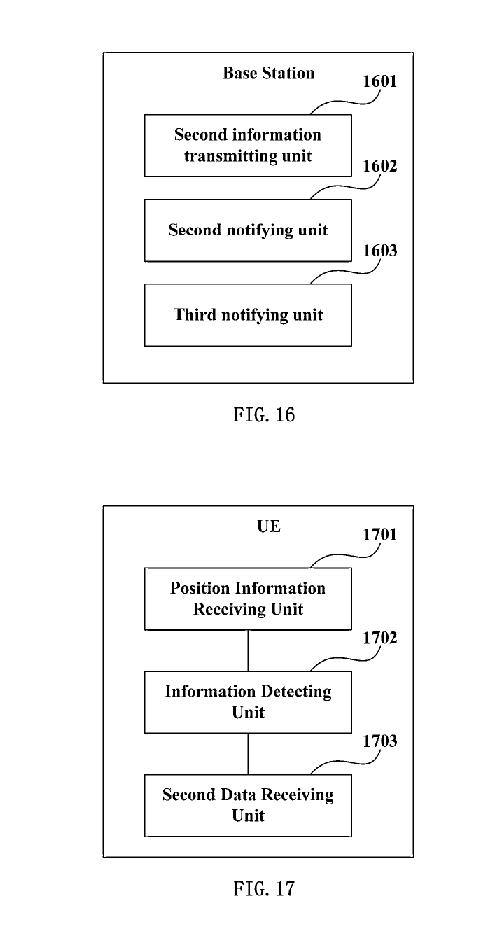

FIG. 16 is a structure diagram of a base station according to Embodiment 14 of the invention. The base station may be of a cell in a set maintained by the UE. For example, the base station may be a macro base station or a pico base station if the set includes a macro cell and a pico cell. As shown in FIG. 16, the base station includes a second information transmitting unit 1601.

The second information transmitting unit 1601 is configured to transmit an E-PDCCH to UE if the enhanced downlink control signaling (E-PDCCH) and a scheduled downlink shared channel (PDSCH) occupy different frequency domain resources, the E-PDCCH including a base station identifier indicating a base station that transmits data.

If the base station is of a main service cell, as shown in FIG. 16, the base station further includes a second notifying unit 1602 which is configured to notify the UE whether to configure the UE with an E-PDCCH on each cell in a set maintained by the UE.

If the base station is of a main service cell, as shown in FIG. 16, the base station may further include a third notifying unit 1603 which is configured to notify the UE of information of transmission position of the E-PDCCH shared by UE of each cell in a set maintained by the UE.

In the embodiment, for example, if the set includes a macro cell and a pico cell, the base station of the main service cell, i.e., the second notifying unit 1602 of the macro base station individually notifies the UE whether to configure the UE with an E-PDCCH on each cell; and the third notifying unit 1603 of the macro base station notifies the UE of information of transmission position of the E-PDCCH shared by UE of each cell in a set maintained by the UE. The second information transmitting unit 1601 of the macro base station transmits to the UE an E-PDCCH including a base station identifier indicating a base station that transmits data. Thus, the UE can receive the E-PDCCH at corresponding area according to the information of transmission position notified by the macro base station. After receiving the E-PDCCH, the UE may acquire the base station identifier indicated by the E-PDCCH, and receive data from the base station to which the base station identifier corresponds.

In the embodiment, if the base station is not of a main service cell, e.g., it is a pico base station, it may include a second information transmitting unit 1601 as mentioned above, which is omitted herein.

FIG. 17 is a structure diagram of UE according to Embodiment 15 of the invention. As shown in FIG. 17, the UE includes a position information receiving unit 1701, an information detecting unit 1702 and a second data receiving unit 1703, wherein,

the position information receiving unit 1701 is configured to receive information of transmission position of an E-PDCCH shared by the UE and UE of each cell in a set maintained by the UE notified by a base station of a main service cell; the information detecting unit 1702 is configured to search for an E-PDCCH of the UE according to the information of transmission position, the E-PDCCH indicating a base station identifier of a base station that transmits data; and the second data receiving unit 1703 is configured to acquire from the E-PDCCH, the base station identifier of the base station that transmits data, and to receive data from the base station to which the base station identifier corresponds.

In which, the information detecting unit 1702 may search for the E-PDCCH at a shared position, and the specific process may adopt any of the prior arts, which is omitted herein. In addition, for example, if the set maintained by the UE includes a macro cell and a pico cell, the base station of the main service cell is a macro base station.

For the one-step E-PDCCH structure in FIG. 10B.

Embodiment 16 of the invention provides a method for transmitting an E-PDCCH, in the embodiment, the resource configuration of the E-PDCCH is as shown in FIG. 10B. The method includes:

transmitting, by a base station that transmits a scheduled PDSCH, an E-PDCCH to UE if the E-PDCCH and the scheduled PDSCH occupy the same frequency domain resource and different time domain resources, wherein the E-PDCCH is transmitted in a data area.

In that case, the E-PDCCH shall be transmitted with the scheduled PDSCH by the same cell base station, without indicating a base station identifier, and the main purpose is to match the precoded matrix. If the E-PDCCH and the data are transmitted by different base stations, the precoded matrix will be different, and the UE cannot decode.

In the embodiment, as shown in FIG. 10B, the specific position of the E-PDCCH of only one UE is pointed out. In the actual application, the system may provide a shared position for the UE configured with the E-PDCCH, and each UE searches for its E-PDCCH at the shared position. In that case, for example if the set includes a macro cell and a pico cell, a main service cell (i.e., the macro cell) notifies the UE of information of transmission position of E-PDCCH shared by UE of each cell in the set maintained by the UE, so that the UE may receive the E-PDCCH at corresponding position; after receiving the E-PDCCH, the UE can acquire related information therefrom by correctly decoding the E-PDCCH.

In the embodiment, the main service cell individually notifies the UE whether to configure the UE with an E-PDCCH on each cell in a set maintained by the UE.

Embodiment 17 of the invention further provides a base station, which may be of any cell in a set maintained by the UE. For example, if the set includes a macro cell and a pico cell, the base station may be a macro base station or a pico base station. The base station may include an information transmitting unit which is configured to transmit an E-PDCCH to UE, if the E-PDCCH and a scheduled PDSCH occupy same frequency domain resource and different time domain resources, the base station being the same base station that transmits the scheduled PDSCH to the UE, wherein the E-PDCCH is transmitted in a data area.

In addition, if the base station is of a main service cell, it may further include a second notifying unit and a third notifying unit as shown in FIG. 16, with the same functions as that shown in FIG. 16, which are omitted herein.

In the embodiment, if the base station is not of a main service cell, it may include an information transmitting unit as described above, which are omitted herein.

In the embodiment, for example, if the set includes a macro cell and a pico cell, the base station of the main service cell, i.e., the second notifying unit of the macro base station individually notifies the UE whether to configure the UE with an E-PDCCH on each cell; and the third notifying unit of the macro base station notifies the UE of information of transmission position of the E-PDCCH shared by UE of each cell in a set maintained by the UE. The information transmitting unit of the macro base station transmits an E-PDCCH to the UE. Thus, the UE can receive the information of transmission position notified by the macro base station, and receive E-PDCCH at corresponding area according to the information of transmission position. After receiving the E-PDCCH, the UE may correctly decode the E-PDCCH to acquire related information therefrom. The situation is similar if the base station is a pico base station, and herein is omitted.

For the E-PHICH, there is still no specific structure.

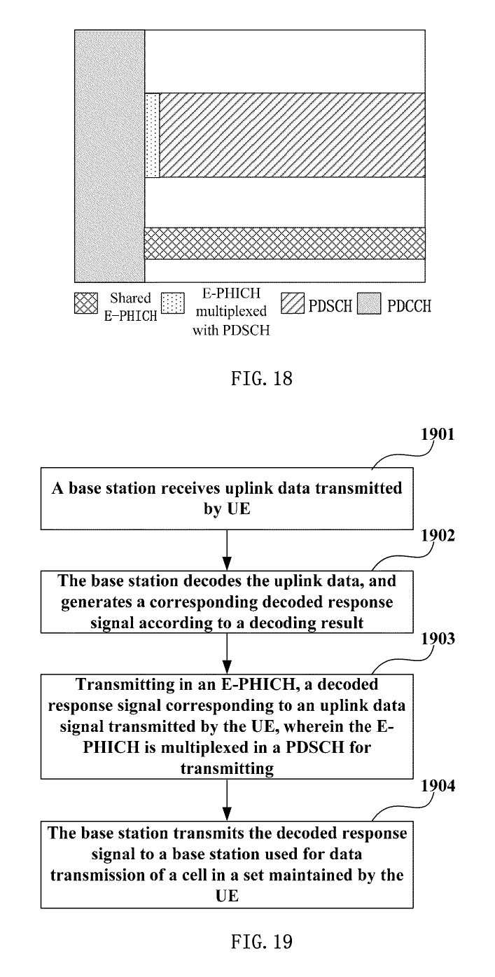

The specific structure is proposed by Embodiment 18 of the invention. FIG. 18 is a configuration diagram of an E-PHICH according to Embodiment 18 of the invention. As shown in FIG. 18, the method for configuring an E-PHICH includes: a base station semi-statically partitions some resources in a data area to be shared by UE for transmitting a decoded response signal (ACK/NACK) corresponding to an uplink data signal; but if data is transmitted to the UE, the E-PHICH is multiplexed in the PDSCH, as shown in FIG. 18, E-PHICH is multiplexed in the PDSCH. In addition, the base station may notify the configured resources to the UE.

Embodiment 19 of the invention provides a method for transmitting a response signal, the method includes:

transmitting a decoded response signal corresponding to an uplink data signal transmitted by UE in an enhanced hybrid-ARQ indicator channel (E-PHICH).

In the embodiment, the response signal may be ACK/NACK.

In one embodiment, if the E-PHICH shares resources with other UE in the semi-statically partitioned resources to transmit the response signal, the base station of the main service cell transmits the response signal. That is, if the E-PHICH can only share the resources with other UE in the semi-statically partitioned resources to transmit the ACK/NACK, the E-PHICH of the UE configured with the DCS mode is transmitted in the main service cell for example by the macro base station. In that case, the E-PHICH is always transmitted in the main service cell, such as by the macro base station.

In another embodiment, if data is to be transmitted to the UE together with the response signal, the base station transmitting the data transmits the pre-acquired response signal and the data to the UE simultaneously, i.e., multiplexes the response signal in the data and transmits them simultaneously. Further, the base station may transmit them to a base station used for data transmission of a cell in a set maintained by the UE. In that case, the base station transmitting the E-PHICH may be not a main service base station (e.g., macro base station). In addition, the method for acquiring the response signal by the base station is similar to the prior art, and herein is omitted.

In addition, in the embodiment of the invention, the method may further include: receiving uplink data transmitted by the UE, decoding the uplink data, and generating corresponding decoded response signal according to a decoding result.

FIG. 19 is a flowchart of a method for transmitting a response signal according to Embodiment 19 of the invention, wherein the description is given by an example where the E-PHICH is transmitted by being multiplexed in a PDSCH. As shown in FIG. 19, the method includes:

step 1901: a base station receives uplink data transmitted by UE;

step 1902: the base station decodes the uplink data, and generates corresponding decoded response signal according to a decoding result.

In which, if the decoding is correct, corresponding acknowledgement response signal such as ACK is generated, otherwise a non-acknowledge response signal such as NACK is generated. The method for acquiring the decoded response signal by the base station is similar to the prior art, and herein is omitted.

Step 1903: the base station transmits in an E-PHICH, a decoded response signal corresponding to the uplink data signal transmitted by the UE.

In which, if data is to be transmitted to the UE together with the response signal, the base station transmitting the data transmits the response signal and the data to the UE simultaneously, i.e., multiplexes the E-PHICH in the PDSCH and transmits them to the UE.

Step 1904: the base station transmits the decoded response signal to a base station used for data transmission of a cell in a set maintained by the UE, so that the UE determines whether to transmit a new data or retransmit the data according to the decoded response signal.

In that case, the base station transmitting the E-PHICH may be not a main service base station (e.g., macro base station). The orders of steps 1903 and 1904 may be exchanged.

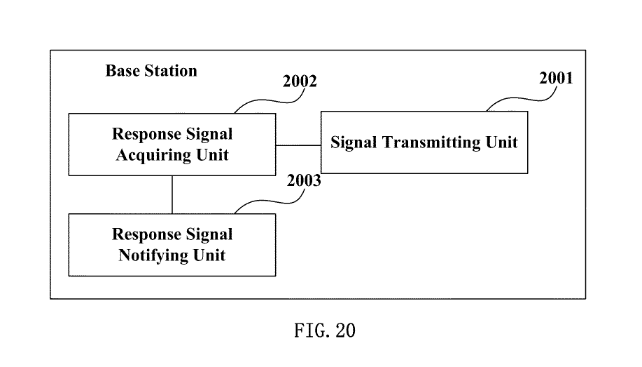

FIG. 20 is a structure diagram of a base station according to Embodiment 2 0 of the invention. As shown in FIG. 20, the base station includes a signal transmitting unit 2001 which is configured to transmit a decoded response signal corresponding to an uplink data signal in an enhanced hybrid-ARQ indicator channel (E-PHICH).

If the E-PHICH shares resources with other UE in the semi-statically partitioned resources to transmit the response signal, the base station is of the main service cell, such as a macro base station.

If data is to be transmitted to the UE together with the response signal, the signal transmitting unit 2001 simultaneously transmits to the UE, the acquired response signal and the data to be transmitted to the UE, i.e., multiplexes the E-PHICH including corresponding signal in the PDSCH and transmits them to the UE.

The base station is a base station transmitting the data, which may be of or not of the main service cell.

As shown in FIG. 20, the base station may further include a response signal acquiring unit 2002 and a response signal notifying unit 2003, wherein the response signal acquiring unit 2002 is configured to receive the uplink data signal transmitted by the UE, and to decode the uplink data signal so as to acquire the decoded response signal of the uplink data signal; the method for acquiring the response signal may be any of the prior art; and the response signal notifying unit 2003 is configured to transmit the response signal to a base station transmitting data of a cell in a set maintained by the UE.

The workflow of the base station is described with reference to FIG. 20. As shown in FIG. 20, the response signal acquiring unit 2002 of the base station receives an uplink data signal transmitted by the UE, and decodes the uplink data signal so as to acquire a decoded response signal thereof. The signal transmitting unit 2001 of the base station transmits the decoded response signal in the E-PHICH; wherein, the E-PHICH including the acquired response signal is multiplexed in a PDSCH for transmission; and the response signal notifying unit 2003 of the base station transmits the decoded response signal to a base station transmitting data of a cell in a set maintained by the UE.

As can be seen from the above embodiment, with the method for configuring the E-PHICH resource proposed by the embodiment of the invention, the E-PHICH transmission is realized, so that the UE may determine whether to retransmit the data or transmit a new data according to the response signal in the E-PHICH.

In the above embodiment, the UE may be a mobile phone, or any other device having the communication capability, such as a gaming machine, a PDA, a portable computer, etc.

The embodiments of the invention further provide a computer-readable program, wherein when executed in a pico base station, enabling a computer to perform the method for transmitting an enhanced control signaling according to Embodiments 1 and 3 in the pico base station.

The embodiments of the invention further provide a storage medium storing a computer-readable program, wherein the computer-readable program enables a computer to perform the method for transmitting an enhanced control signaling according to Embodiments 1 and 3 in a pico base station.

The embodiments of the invention further provide a computer-readable program, when executed in UE, enabling a computer to perform the method for determining a starting position of PDSCH according to Embodiments 2 and 4 in the UE.

The embodiments of the invention further provide a storage medium storing a computer-readable program, wherein the computer-readable program enables a computer to perform the method for determining a starting position of PDSCH according to Embodiments 2 and 4 in a terminal.

The embodiments of the invention further provide a computer-readable program, when executed in a base station, enabling a computer to perform the method for transmitting an enhanced control signaling according to Embodiments 9, 12, 16 and 19 in the base station, including the methods for transmitting an E-PCFICH, an E-PDCCH and a response signal (E-PHICH).

The embodiments of the invention further provide a storage medium storing a computer-readable program, wherein the computer-readable program enables a computer to perform the method for transmitting an enhanced control signaling according to Embodiments 9, 12, 16 and 19 in a base station, including the methods for transmitting an E-PCFICH, an E-PDCCH and a response signal (E-PHICH).

The embodiments of the invention further provide a computer-readable program, when executed in UE, enabling a computer to perform the method for receiving data according to Embodiments 9 and 13 in the UE.

The embodiments of the invention further provide a storage medium storing a computer-readable program, wherein the computer-readable program enables a computer to perform the method for receiving data according to Embodiments 9 and 13 in UE.

As can be seen from the above embodiments, an effective method for transmitting an enhanced control signaling is provided, thereby solving the problem that the enhanced control signaling cannot be transmitted at present, and the problems in the application existed when the enhanced control signaling is introduced into the CoMP.

The embodiments of the invention provide a method for transmitting an E-PCFICH and a method for determining a starting position of a PDSCH, wherein the E-PCFICH is adopted in a pico cell, and the signaling includes a control signaling length which is of the pico cell, or a maximum value of control signaling lengths of the macro cell and the pico cell. Thus the UE can acquire the maximum value of the control signaling lengths of the macro cell and the pico cell, and determine the starting position of the data area PDSCH of the pico cell according to the maximum value, thereby solving the problem that the data area of the pico cell cannot be determined accurately under the CoMP mode, and ensuring that the UE correctly receives data.

For the structures of one-step E-PDDCH and two-step E-PDCCH, the embodiments of the invention provide a method for transmitting an E-PDCCH. In the structure of two-step E-PDCCH, a base station of a main service cell transmits to UE, first DCI including a base station identifier indicating a base station that transmits second DCI, wherein the second DCI includes a base station identifier indicating a base station that transmits data. In the structure of one-step E-PDCCH, a cell base station transmits to UE, an E-PDCCH indicating a base station identifier of a base station that transmits data, if the E-PDCCH and a scheduled PDSCH occupy different frequency domain resources; or a base station transmitting the scheduled PDSCH transmits the E-PDCCH to the UE, if the E-PDCCH and the scheduled PDSCH occupy the same frequency domain resource and different time domain resources. Thus an effective method for transmitting the E-PDCCH is provided, so that the UE may acquire corresponding information.

For the E-PHICH, the embodiments of the invention provide a method for transmitting a response signal in the E-PHICH, so that the UE may determine whether to retransmit the data or transmit a new data according to the response signal in the E-PHICH.

One or more functional blocks described in FIGS. 7-9, 13-14, 16-17 and 20 and/or one or more combinations thereof may be implemented as a general processor, a digital signal processor (DSP), an application-specific integrated circuit (ASIC), a field-programmable gate array (FPGA) or other programmable logic device, discrete gate or transistor logic device, discrete hardware component or any combination thereof, or combinations of computing devices, such as a combination of DSP and microprocessor, a plurality of microprocessors, one or more microprocessors communicatively combined with the DSP, or any other such device.

Although the specific examples of the invention are described in the application, a person skilled in the art can design the modifications to the invention without deviating from the concept of the invention.

The above apparatuses and methods of the invention may be implemented by hardware, or a combination of hardware and software. The invention relates to a computer readable program which when being executed by a logic part, enables the logic part to implement the aforementioned apparatuses or constituent parts, or enables the logic part to implement the aforementioned methods or steps. The logic part for example may be a field programmable logic part, a microprocessor, a processor used in the computer, etc. The invention further relates to a storage medium for storing the above program, such as hard disc, magnetic disc, optical disc, DVD, flash memory, etc.

The invention is described as above in conjunction with the specific embodiments. But a person skilled in the art shall appreciate that those descriptions are just exemplary, rather than limitations to the protection scope of the invention. A person skilled in the art can make various modifications and changes to the invention based on the spirit and the principle of the invention, and those modifications and changes also fall within the scope of the invention.

What is claimed is:

1. A pico base station, applicable to a coordinated multipoint transmission mode, the pico base station comprising:
a first transmitting unit, configured to transmit an enhanced physical control format indication signaling including control signaling length to user equipment configured with the mode;
wherein the control signaling length is of a pico cell, or a maximum value of control signaling lengths of a macro cell and a pico cell.

2. The pico base station according to claim 1, wherein, if the control signaling length is a maximum value of control signaling lengths of the macro cell and the pico cell, the pico base station further comprising:
a first information acquiring unit, configured to acquire control signaling length of the macro cell; and
a first selecting unit, configured to select the maximum value of control signaling lengths of the pico cell and the macro cell.

3. User equipment, configured with a coordinated multipoint transmission mode, the user equipment comprising:
a second information acquiring unit, configured to acquire a maximum value of control signaling lengths of a macro cell and a pico cell in a set maintained by the user equipment; and
a first determining unit, configured to determine a starting position of a data area of the pico cell according to the maximum value.

4. The user equipment according to claim 3, wherein the second information acquiring unit comprises:
a first receiving unit, configured to receive physical control format indication signaling including control signaling length of the macro cell transmitted by a macro base station and an enhanced physical control format indication signaling including control signaling length of the pico cell transmitted by a pico base station; and
a second selecting unit, configured to select a maximum value of control signaling lengths of the pico cell and the macro cell.

5. The user equipment according to claim 3, wherein the second information acquiring unit is specifically configured to receive an enhanced physical control format indication signaling including control signaling length transmitted by a pico base station; the control signaling length is a maximum value of control signaling lengths of the macro cell and the pico cell.

6. A base station, of a main service cell under a coordinated multipoint transmission mode, the base station comprising:
a first information transmitting unit, configured to transmit first downlink control information to user equipment, wherein the first downlink control information is transmitted in a control area of the main service cell, and includes a base station identifier indicating a base station that transmits second downlink control information.

7. The base station according to claim 6, further comprising:
a first notifying unit, configured to notify the user equipment whether to configure the user equipment with an enhanced downlink control channel on each cell in a set maintained by the user equipment.

8. User equipment, comprising:
a first detecting unit, configured to detect first DCI from a traditional area of a main service cell, and to acquire a position where second DCI is present from the first DCI; wherein the position where the second DCI is present is a base station identifier CI of a base station where the second DCI is present;
a second detecting unit, configured to detect the second DCI in a base station to which the base station identifier corresponds according to the base station identifier detected by the first detecting unit; and
a first data receiving unit, configured to receive data from the base station to which the base station identifier detected by the first detecting unit corresponds.

9. A base station, applicable to a coordinated multipoint transmission mode, the base station comprising:
a second information transmitting unit, configured to transmit an enhanced downlink control signaling to user equipment if the enhanced downlink control signaling (E-PDCCH) and a scheduled downlink shared channel (PDSCH) occupy different frequency domain resources, the enhanced downlink control signaling including a base station identifier indicating a base station that transmits data; and to transmit the enhanced downlink control signaling to the user equipment if the enhanced downlink control signaling and the scheduled downlink shared channel occupy the same frequency domain resource and different time domain resources, the base station being the same base station that transmits the scheduled downlink shared channel; wherein the enhanced downlink control signaling is transmitted in a data area.

10. The base station according to claim 9, wherein the base station is of a main service cell, and further comprises:
a second notifying unit, configured to notify the user equipment whether to configure the user equipment with an enhanced downlink control channel on each cell in a set maintained by the user equipment.

11. The base station according to claim 9, wherein the base station is of a main service cell, and further comprises:
a third notifying unit, configured to notify the user equipment of information of transmission position of the enhanced downlink control signaling shared by user equipment of each cell in a set maintained by the user equipment.

12. User equipment, applicable to a coordinated multipoint transmission mode, the user equipment comprising:
an information detecting unit, configured to search for an enhanced downlink control signaling of the user equipment according to predetermined information of transmission position of the enhanced downlink control signaling, the enhanced downlink control signaling including a base station identifier indicating a base station that transmits data; and
a second data receiving unit, configured to acquire the base station identifier of the base station that transmits data from the enhanced downlink control signaling, and to receive data from the base station to which the base station identifier corresponds.

13. The user equipment according to claim 12, wherein, the user equipment further comprising:
a position information receiving unit, configured to receive information of transmission position of an enhanced downlink control signaling shared by the user equipment and user equipment of each cell in a set maintained by the user equipment notified by a base station of a main service cell.

14. A base station, applicable to a coordinated multipoint transmission mode, the base station comprising:
a signal transmitting unit, configured to transmit a decoded response signal corresponding to an uplink data signal transmitted by user equipment in an enhanced hybrid-ARQ indicator channel (E-PHICH); wherein the signal transmitting unit transmits the acquired response signal and data needing to be transmitted to the user equipment simultaneously to the user equipment.

15. The base station according to claim 14, wherein, the base station further comprising:
a response signal acquiring unit, configured to receive the uplink data signal transmitted by the user equipment, and to decode the uplink data signal so as to acquire the decoded response signal of the uplink data signal; and
a response signal notifying unit, configured to transmit the response signal to a base station of a cell for data transmission in a set maintained by the user equipment.
